(19) United States
(12) Patent Application Publication
(10) Pub. No.: US 2018/0184694 A1
(43) Pub. Date: Jul. 5, 2018

(54) PREPARATION METHOD OF NOODLE WITH ENHANCED COOKING CONVENIENCE

(71) Applicant: PULMUONE CO., LTD., Eumseong-gun (KR)

(72) Inventors: Seung-Woo NAM, Seoul (KR); Ik-Hyun YEO, Seoul (KR); Sang-Yun LEE, Seoul (KR); Jung-Gun CHO, Cheongju-si (KR); Youn-Sung CHO, Seoul (KR); Ji Hun YUN, Seoul (KR)

(21) Appl. No.: 15/797,751

(22) Filed: Oct. 30, 2017

(30) Foreign Application Priority Data
Dec. 30, 2016 (KR) 10-2016-0184253

(51) Int. Cl. A23L 7/113; A21D 8/02; A23L 5/10; A23L 23/00

(52) U.S. Cl. CPC A23L 7/113; A21D 8/02; A23V 2002/00; A23L 23/00; A23L 5/13

(57) ABSTRACT

Provided is a method of preparing noodles with enhanced cooking convenience. Noodles according to the present invention can be immediately cooked without an additional boiling process.

### CROSS-REFERENCE TO RELATED APPLICATION

This application claims priority to and the benefit of Korean Patent Application No. 10-2016-0184253, filed on Dec. 30, 2016, the disclosure of which is incorporated herein by reference in its entirety.

### BACKGROUND

### 1. Field of the Invention

The present invention relates to a method of preparing noodles with enhanced cooking convenience.

### 2. Discussion of Related Art

As the population of working couples and the population of people living-alone are increasing, the demand for convenient food or instant food is also increasing. Recently, foods, such as rice, fried rice, topped rice, spaghetti, udong, gom-tang, soup, stew, and the like, have been developed into convenient food. For example, Korean Patent Laid-open Publication No. 10-2015-0045829 discloses duck soup retort food, and Korean Patent Laid-open Publication No. 10-2013-0004931 discloses retort food using seafood. In such instant food, taste is important but how convenient and fast cooking can be performed after the instant food is removed from a packing material is very important.

While researching improvements to the inconvenience during cooking of instant foods, such as udong, fried udong, or the like, because noodles do not properly disperse, the inventors have developed a method of preparing noodles, whereby cooking can be immediately performed without performing a process of boiling noodles separately after an instant food is removed from a packing material, and the inventors have completed the present invention.

### SUMMARY OF THE INVENTION

The present invention is directed to a method of preparing noodles, whereby cooking can be performed without an additional process of boiling noodles.

According to an aspect of the present invention, there is provided a method of preparing noodles, including: making dough by mixing flour, starch, and fat powder; making a noodle stem using the dough; forming noodle strings by rolling and discharging the noodle stem; steaming the noodle strings; and boiling the steamed noodle strings.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is photos showing a state of noodles before cooking after removing the noodles from a packing material according to Example 1 and Comparative Example 1;

FIG. 2 is photos of the noodles cooked using a frying pan according to Example 1 and Comparative Example 1;

FIG. 3 is photos of noodles cooked using a microwave oven according to Example 1 and Comparative Example 1; and

FIG. 4 is scanning electron microscope (SEM) photos of a surface and a cross-section of noodles according to Example 1 and Comparative Examples 1 through 3.

### DETAILED DESCRIPTION OF EXEMPLARY EMBODIMENTS

The present invention is directed to a method of preparing noodles, including: making dough by mixing flour, starch, and fat powder; making a noodle stem using the dough; forming noodle strings by rolling and discharging the noodle stem; steaming the noodle strings; and boiling the steamed noodle strings.

The present invention is also directed to instant food including the noodles according to the present invention; and a cooking source.

Hereinafter, the present invention will be described in detail.

Making Dough

The method of preparing noodles according to the present invention includes making dough by mixing flour, starch, and fat powder. The dough is made using a general udong noodle making method, but is not specially limited thereto.

In this case, the dough may be made by mixing 20 to 32 parts by weight of starch with respect to 100 parts by weight of flour. When the amount of starch is within the above range, a restoration property of the noodles, i.e., cooking convenience in which the noodles immediately disperse and are cooked, is excellent. General starch used in udong noodle dough may be used as the starch, but the starch is not specially limited thereto. For example, the starch may be potato starch, sweet potato starch, tapioca starch, or the like. Preferably, the starch is tapioca starch, but is not limited thereto.

In this case, the dough may be made by mixing 1 to 4.5 parts by weight of fat powder with respect to 100 parts by weight of flour. When the amount of fat powder is within the above range, the restoration property of the noodles, i.e., cooking convenience in which the noodles immediately disperse and are cooked, is excellent. Preferably, the fat powder may be made by powdering vegetable oils and fats. For example, the fat powder may be palm oil powder, coconut oil powder, palm kernel oil powder, cacao oil powder, or the like. The fat powder may be a commercially-sold product. 1 to 4.5 parts by weight of the fat powder are included in the flour so that, when the noodles are cooked, dispersion of moisture is increased and starch elution and aging is prevented.

In this case, the dough may be prepared by additionally including salt and water in addition to the flour, the starch, and the fat powder. In this case, preferably, 1 to 3.5 parts by weight of salt and 40 to 65 parts by weight of water with respect to 100 parts by weight of flour is used.

Making Noodle Stem

The method of preparing noodles according to the present invention further includes making a noodle stem using the dough. The noodle stem may be made using a general method of preparing noodles such as udong noodles, but is not specially limited thereto.

Combining

The method of preparing noodles according to the present invention further includes a combining operation of stacking the noodle stem. This operation may be performed using a general method of preparing noodles such as udong noodles, but is not specially limited thereto.

Discharging and Forming Noodle Strings

The method of preparing noodles according to the present invention further includes forming noodle strings by rolling and discharging the noodle stem. This operation may be made using a general method of preparing noodles such as udong noodles, but is not specially limited thereto.

Steaming

The method of preparing noodles according to the present invention further includes steaming the noodle strings. The steaming operation may be performed by applying steam having a temperature of 85 to 103° C. to the noodle strings for 3 to 7 minutes. In this case, the steaming operation is more preferably performed by spraying water (adding water using a spray method) onto the noodle strings. The noodle strings are steamed by spraying water (adding water) in this way so that the noodle strings become sufficiently sticky and the noodles have a soft material property. When only steaming is performed without adding water (water spray), the noodles have a hard texture of food and the restoration property and cooking convenience of the noodles are deteriorated. In this case, the addition of water may be performed using room-temperature water, but is not specifically limited thereto.

Cutting

The method of preparing noodles according to the present invention may further include cutting the steamed noodle strings. The cutting operation may be performed using a general method of preparing noodles such as udong noodles, but is not specially limited thereto.

Boiling

The method of preparing noodles according to the present invention further includes boiling the steamed noodle strings. The boiling operation may also be performed by boiling the steamed and cut noodle strings. Preferably, the boiling operation is performed by boiling the noodle strings in hot water for 1 to 6 minutes.

Cooling

The method of preparing noodles according to the present invention may further include cooling the boiled noodle strings. The cooling operation may be performed by immersing the boiled noodle strings in cold water.

Acid Immersing

The method of preparing noodles according to the present invention may further include immersing the boiled noodle strings in an acidic solution. The acid immersing operation may be performed by immersing the noodle strings in an acidic solution. The acidic solution may be prepared by adding an acidulant to water. For example, the acidic solution may be prepared by diluting 3 wt % of an acidulant, such as lactic acid, maltitol syrup, acetic acid, citric acid, DL-malic acid, sodium acetate, and trisodium citrate, in water having a temperature of 22 to 25° C.

Coating

The method of preparing noodles according to the present invention may further include coating the boiled noodle strings. In this case, the boiled noodle strings may be used in the coating operation after undergoing the cooling and/or acid immersing operation. The coating operation may be performed by entirely or partially coating surfaces of the noodle strings.

The coating operation may be performed by coating the surfaces of the noodle strings with soybean polysaccharide and oil. Preferably, the soybean polysaccharide is a tofu residue. The oil may be corn germ oil, sunflower oil, grape seed oil, canola oil, soybean oil, or the like. Preferably, the oil is corn germ oil. The surfaces of the noodle strings are coated with the soybean polysaccharide and oil so that the restoration property and cooking convenience of the noodles can be enhanced. The soybean polysaccharide, which is a polysaccharide mixture obtained by extracting, refining, and concentrating dietary fiber of soybeans, includes rhamnose, fucose, arabinose, xylose, galactose, uronic acid, and mannose.

Packing

The method of preparing noodles according to the present invention may further include a packing operation of putting the boiled noodle strings into a packing material. In this case, the boiled noodle strings may be used in the packing operation after undergoing the cooling operation, the acid immersing operation, and/or coating operation.

In this case, a packing material having a size of (172 to 187 mm)×(142 to 157 mm) for 180 g of the noodle strings is used so that an available space is formed in the packing material, and thus a flowing property of the noodles is enhanced and a dispersion characteristic of the noodles can be enhanced. The packing material may be formed of a material such as linear low density polyethylene (LLDPE), and more preferably, a thin material.

Noodles According to the Present Invention

Noodles according to the present invention can be immediately cooked without performing a process of boiling the noodles separately. The noodles according to the present invention have an excellent dispersion characteristic, excellent elasticity, and excellent cooking convenience. Also, the noodles according to the present invention have many pores on their surfaces. When the noodles are adhered to each other, they separate from each other well.

That is, unlike an existing frying pan cooking process in which noodles removed from the packing material are boiled, the boiled water is thrown out, and the noodles are then cooked by being fried together with a sauce, the noodles according to the present invention do not require a process of boiling the noodles. Also, unlike an existing process in which noodles removed from the packing material are boiled, the boiled water is thrown out, and the noodles are then cooked using a microwave oven together with the sauce, the noodles according to the present invention do not require a process of boiling the noodles. Also, even when the noodles are removed from the packing material and are then not separately boiled but are put into the microwave oven with a sauce from the beginning, dispersion of the noodles and a boiling time thereof are not separately required, and thus a microwave oven cooking time can be reduced.

The noodles according to the present invention may be udong noodles, kalguksu noodles, or fried noodles (for example, udong noodles, Chinese noodles, Yakisoba, or the like), but are not limited thereto.

Instant Food

The present invention is directed to instant food including the noodles according to the present invention and a cooking sauce. The instant food may be retort food. The instant food may be udong, kalguksu, fried noodles, or the like (udong, Chinese noodles, Yakisoba, or the like). In the instant food according to the present invention, the noodles are cooked together with the sauce, and the noodles do not need to be separately boiled before the sauce is put onto the noodles.

The cooking sauce, which is a sauce to be cooked together with the noodles, may be an udong sauce, a fried udong sauce, or the like.

<Material and Method>

Tapioca starch was purchased and used as starch. A commercially-sold palm oil powdered product was purchased and used as fat powder. A commercially-sold product including Xanthan gum and corn starch was purchased and used as a hydrophilic polymer. A commercially-sold product extracted, filtered, and refined from soybeans (rhamnose, fucose, arabinose, xylose, galactose, uronic acid, and mannose originated from soybeans) was purchased and used as soybean polysaccharide.

### Example 1

100 kg of flour (medium flour), 25 kg of starch, 2.76 of kg salt, 2.50 of kg fat powder, and 52.5 kg of water were mixed to make dough, and the dough was formed as a noodle stem. Then, the noodle stem was stacked (combined), rolled, and discharged. Then, after room-temperature water was sprayed onto discharged noodle strings using a water-adding nozzle and the noodle strings were steamed (using steam of 98° C. for 5 minutes), the noodle strings were cut to a predetermined length. The cut noodles were boiled for 3 minutes and then cooled. The cooled noodles were immersed in an acidic solution, the immersed noodles were scooped, and surfaces of the noodles were coated with 0.78 kg of liquid-state soybean polysaccharide and 4.69 kg of corn germ oil, thereby preparing the noodles.

### Comparative Example 1

The noodles were prepared using the same method as that of Example 1 except that a steaming process was not performed. That is, in Comparative Example 1, the noodle stem was stacked (combined), rolled, and discharged, and then the discharged noodle strings were immediately cut, boiled, and cooled, thereby preparing the noodles.

### Comparative Example 2

The noodles were prepared using the same method as that of Example 1 except that a boiling process was not performed. That is, in Comparative Example 2, the noodles were cut and then immediately cooled without the boiling process, were immersed in the acidic solution, thereby preparing the noodles.

### Comparative Example 3

The noodles were prepared using the same method as that of Example 1 except that the boiling process was not performed and a water spraying process was not performed during the steaming process. That is, in Comparative Example 3, the noodles were simply steamed in a state in which water was not sprayed onto the discharged noodle strings, a cutting process was performed, and then the cooling and acidic solution immersing processes were performed without the boiling process, thereby preparing the noodles.

### Comparative Example 4

The noodles were prepared using the same method as that of Example 1 except that liquid-state soybean polysaccharide coating was not performed after the acidic solution immersing operation was performed and only a corn germ oil coating operation was performed.

### Comparative Example 5

The noodles were prepared using the same method as that of Example 1 except that no fat powder were used when the dough was made. That is, in Comparative Example 5, the dough was made using flour, starch, salt, and water, thereby preparing the noodles.

### <Experimental Example 1> Evaluation of Cooking Convenience

<1-1> Dispersion of Noodles after Opening

The noodles according to Example 1 and the noodles according to Comparative Example 1 were put into a packing material formed of an LLDPE material, were refrigerated (at 4° C.) for 48 hours, and then the packing material was opened.

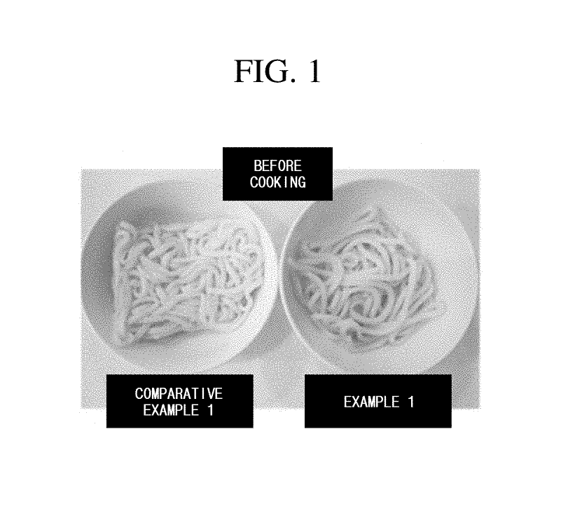

As a result, when the noodles according to Example 1 were removed from the packing material, the noodles were quickly loosened, while the noodles according to Comparative Example 1 were a lump having the shape of the packing material (FIG. 1).

<1-2> Evaluation of Frying Pan Cooking

A frying pan was put on a home gas stove and was preheated with cooking oil for 30 seconds. The noodles according to Example 1 and the noodles according to Comparative Example 1 were put into the preheated frying pan and fried for 30 seconds.

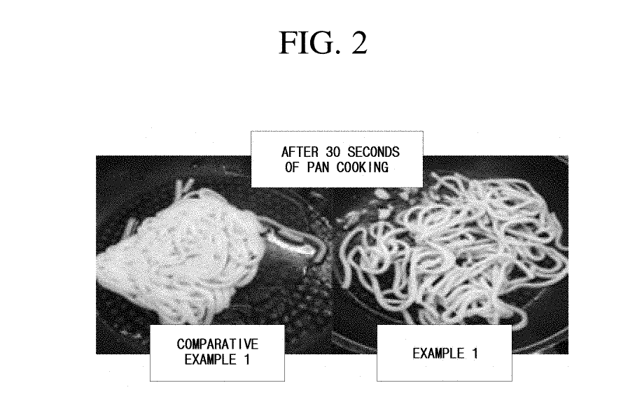

As a result, the noodles according to Example 1 completely loosened so that cooking convenience was enhanced, and the noodles according to Comparative Example 1 weren't loosened well, and thus it was difficult to separate the noodles using cookware. Also, the noodles according to Example 1 were fried with oil. However, the noodles according to Comparative Example 1 were not fried well in a lump state (FIG. 2). Thus, it was ascertained that the noodles according to Example 1 had an excellent dispersion characteristic and could be cooked easily using a frying pan immediately (i.e., without an additional noodle-boiling process).

<1-3> Evaluation of Microwave Oven Cooking

The noodles according to Example 1 and the noodles according to Comparative Example 1 were put into a 1,000 W home microwave oven and cooked.

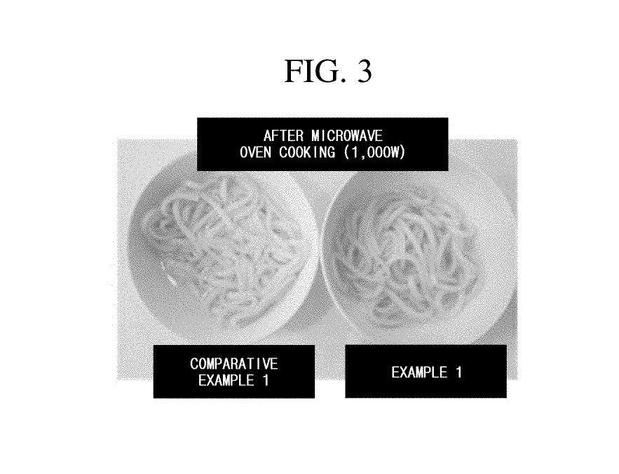

As a result, the noodles according to Example 1 were completely loosened and boiled after being cooked for 3 minutes and 30 seconds using the microwave oven. However, the noodles according to Comparative Example 1 were in the lump state, and surfaces of the noodles in the lump state were hot while the insides thereof were not properly boiled. Also, as a result of observing eluted water with the naked eye, the noodles according to Comparative Example 1 were murkier than the noodles according to Example 1 (FIG. 3). Thus, it was determined that the noodles according to Example 1 had less starch elution during a cooking operation and a higher restoration property than the noodles according to Comparative Example 1.

### <Experimental Example 2>

Material properties of the noodles according to Example 1 and Comparative Examples 1 through 3 were evaluated after the cooking operation was performed.

<2-1> Evaluation of Material Properties During Cooking with Boiling Water

180 g of the noodles according to Example 1 and Comparative Examples 1 through 3 were put into 500 cc of hot water and cooked for 2 minutes. Then, a change of the water during cooking, a weight, a volume, a degree of turbidity, hardness, adhesiveness, springiness, and cohesiveness of the noodles after cooking were evaluated.

Content of water before and after cooling was calculated by measuring the content of water after the noodles were dried at 105° C., and turbidity, which is a value indicating a degree of an eluted solid material, was indicated by 675 mm absorbance using a spectrophotometer (UVmini-1240, Shimadzu, Japan) after water with the boiled noodles was cooled to room temperature. Hardness, springiness, cohesiveness, and adhesiveness of a cooked surface, i.e., a texture of the cooked raw noodles, were repeatedly measured 5 times using a texture analyzer (TA plus, LLoyD Instruments Ltd, England) and was indicated by an average value. In this case, a noodle stem of the raw noodles was cut to a predetermined size (length: 50 mm), was cooked in the same conditions as those of a cooking characteristic experiment of the raw noodles, one noodle string was then put on a platform and measured using a circular probe having a diameter of 13 mm, and measurement conditions were set to a test speed of 2.00 mm/min, a trigger of 0.005 kgf, a sample length of 5 mm, and a sample compression of 70%.

Also, a rate of increase of the content of water was calculated using the following equation 1.

Rate of increase of content of water (%)={(content of water after cooking−content of water before cooking)/content of water before cooking}×100 (1)

As a result, it was ascertained that a value of turbidity of a soup of the noodles according to Example 1 was significantly lower than that of the noodles according to Comparative Example 1, and thus a degree of loss of starch elution and a solid material of the noodles of Example 1 were lower than those of the noodles according to Comparative Example 1. Also, it was ascertained that the rate of increase of the content of water of the noodles according to Example 1 was higher than that of the noodles according to Comparative Example 1, and thus the cooking convenience and restoration property of the noodles according to Example 1 were higher than those of the noodles according to Comparative Example 1. Also, the noodles according to Comparative Example 1 had stronger adhesiveness than that of the noodles according to Example 1. It was determined that the noodles according to Comparative Example 1 had a higher degree of starch elution than that of the noodles according to Example 1, and thus adhesiveness was increased due to starch-originated viscosity (Table 1).

TABLE 1

| | | Comparative | Comparative | Comparative |
|---|---|---|---|---|
| | Example 1 | Example 1 | Example 2 | Example 3 |
| Water content before | 57.9 | 59.5 | 45.6 | 38.1 |
| cooking (wt %) | | | | |
| Water content after | 68.1 | 68.1 | 60.8 | 56.8 |
| cooking (wt %) | | | | |
| Rate of water content | 17.82 | 14.45 | 33.33 | 49.08 |
| increase (%) | | | | |
| Weight after cooking | 43.53 ± 0.306b | 42.77 ± 0.25a | 79.73 ± 0.416c | 87.67 ± 0.404d |
| (g)*** | | | | |
| Volume after cooking | 50.50 ± 0.500a | 50.33 ± 0.289a | 60.50 ± 0.500b | 62.50 ± 0.500c |
| (mL)*** | | | | |
| Turbidity after | 0.145 ± 0.002c | 0.169 ± 0.005d | 0.133 ± 0.004b | 0.125 ± 0.002a |
| cooking | | | | |
| (O.D at 675 nm)*** | | | | |
| Hardness*** | 2534 ± 57.03a | 2752 ± 77.53b | 3540 ± 73.92c | 3743 ± 80.26d |
| Adhesiveness*** | 0.4690 ± 0.22b | 0.5986 ± 0.01c | 0.1076 ± 0.19a | 0.1286 ± 0.17a |
| Springiness*** | 0.7383 ± 0.015a | 0.7863 ± 0.004b | 0.9320 ± 0.010c | 0.9753 ± 0.12d |
| Cohesiveness*** | 0.5330 ± 0.153a | 0.5833 ± 0.015a | 0.9167 ± 0.035b | 0.9800 ± 0.070b |

***p < 0.001

<2-2> Evaluation of Material Property During Microwave Oven Cooking

180 g of the noodles according to Example 1 and Comparative Examples 1 through 3 were put into 300 cc of water and cooked using a microwave oven for 3 minutes and 30 seconds. Then, a change of water during cooking, a weight, a volume, a degree of turbidity, hardness, adhesiveness, springiness, and cohesiveness of the noodles after cooking were evaluated in the same way as that of the above <2-1>.

As a result, it was ascertained that, even in microwave oven cooking, a value of turbidity of a soup of the noodles according to Example 1 was significantly lower than that of the noodles according to Comparative Example 1, and thus a degree of loss of starch elution and a solid material of the noodles of Example 1 were lower than those of the noodles according to Comparative Example 1. Also, it was ascertained that the rate of increase of the content of water of the noodles of Example 1 was higher than that of the noodles according to Comparative Example 1, and thus the cooking convenience and restoration property of the noodles of Example 1 were higher than those of the noodles according to Comparative Example 1. Also, it was ascertained that the noodles according to Example 1 has lower cohesiveness than that of the noodles according to Comparative Example 1, and thus the restoration property of the noodles according to Example 1, i.e., cooking convenience, was higher than that of the noodles according to Comparative Example 1. However, there was no significant difference in hardness and springiness of the noodles according to Example 1 and the noodles according to Comparative Example 1 (Table 2).

TABLE 2

| | | Comparative | Comparative | Comparative |
|---|---|---|---|---|
| | Example 1 | Example 1 | Example 2 | Example 3 |
| Water content before | 57.9 | 59.5 | 45.6 | 38.1 |
| cooking (wt %) | | | | |
| Water content after | 68.1 | 66.5 | 56.8 | 51.7 |
| cooking (wt %) | | | | |
| Rate of water content | 17.62 | 11.76 | 24.58 | 36.70 |
| (%) | | | | |
| Weight after cooking | 23.67 ± 0.379b | 21.73 ± 0.252a | 31.33 ± 0.153c | 46.33 ± 0.321d |
| (g)*** | | | | |
| Volume after cooking | 46.17 ± 0.289b | 44.83 ± 0.764a | 51.67 ± 0.577c | 55.83 ± 0.764d |
| (mL)*** | | | | |
| Turbidity after | 0.0480 ± 0.0008b | 0.0725 ± 0.0004d | 0.0443 ± 0.002a | 0.0530 ± 0.002c |
| cooking | | | | |
| (O.D at 675 nm)*** | | | | |
| Hardness*** | 2674 ± 98.28a | 2832 ± 22.55a | 3276 ± 135.72b | 3462 ± 69.18c |
| Adhesiveness*** | 0.4973 ± 0.073b | 0.6687 ± 0.048c | 0.2590 ± 0.059a | 0.2812 ± 0.071a |
| Springiness*** | 0.7977 ± 0.188a | 0.8030 ± 0.011a | 0.8697 ± 0.029b | 0.9387 ± 0.0211c |
| Cohesiveness*** | 0.4267 ± 0.025a | 0.5167 ± 0.051b | 0.8900 ± 0.100c | 0.9500 ± 0.036c |

***p < 0.001

### <Experimental Example 3>

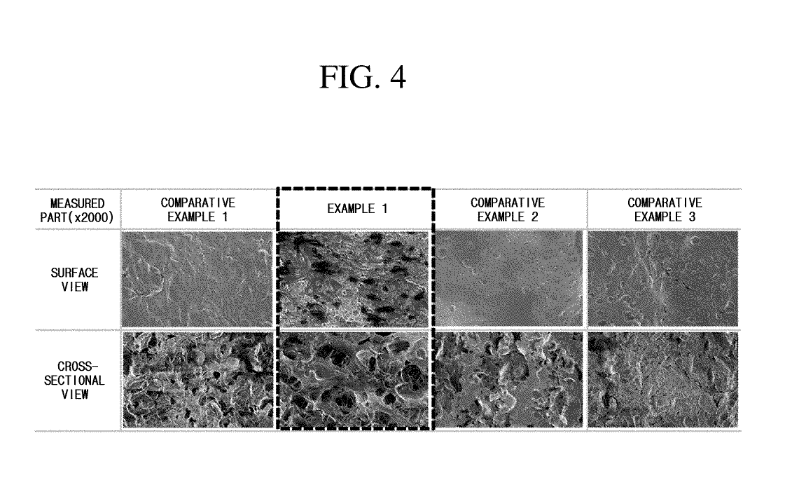

As a result of observing a surface and cross-section of the noodles according to Example 1 and Comparative Examples 1 through 3 using a scanning electron microscope (SEM), it was ascertained that pores of the surface and the cross-section of the noodles according to Example 1 were significantly more than those of the noodles according to Comparative Examples 1 through 3 (FIG. 4). It was determined that small pores were generated in a surface of a texture as the noodles according to Example 1 underwent primary degeneration (starch boiling and protein degeneration) during the steaming process and the content of water was increased by performing boiling on the primarily-degenerated texture. Thus, it was determined that the noodles according to Example 1 had more surface pores than those of the noodles according to Comparative Examples 1 through 3, and thus it was easy to control the noodles when the noodles were adhered to each other, and the noodles according to Example 1 had a higher restoration property and cooking convenience than those of the noodles according to Comparative Examples 1 through 3.

### <Experimental Example 4>

After the noodles according to Example 1 and Comparative Examples 4 and were put into a packing material formed of the LLDPE material and refrigerated (4° C.) for 48 hours, the packing material was opened. The noodles according to Example 1 and Comparative Examples 4 and 5 were put into 300 cc of water and cooked for 3 minutes and 30 seconds using a microwave oven.

As a result, it was ascertained that the restoration property and cooking convenience of the noodles according to Example 1 were higher than those of the noodles according to Comparative Examples 4 and 5. In particular, the noodles according to Comparative Example 4 nearly maintained in a shape of the packing material even after being cooked using the microwave oven.

As described above, noodles prepared using the method of preparing noodle according to the present invention can be immediately cooked without an additional process of boiling the noodles after being removed from a cooking material.

It should be apparent to those skilled in the art that various modifications can be made to the above-described exemplary embodiments of the present invention without departing from the spirit or scope of the invention. Thus, the present invention is intended to cover all such modifications provided they come within the scope of the appended claims and their equivalents.

What is claimed is:

1. A method of preparing noodles, comprising:
making dough by mixing flour, starch, and fat powder;
making a noodle stem using the dough;
forming noodle strings by rolling and discharging the noodle stem;
steaming the noodle strings; and
boiling the steamed noodle strings.

2. The method of claim 1, wherein the dough is made by mixing 20 to 32 parts by weight of starch with respect to 100 parts by weight of flour.

3. The method of claim 1, wherein the dough is made by mixing 1 to 4.5 parts by weight of fat powder with respect to 100 parts by weight of flour.

4. The method of claim 1, wherein the fat powder comprise vegetable fat.

5. The method of claim 1, wherein the steaming is performed by applying steam having a temperature of 85 to 103° C. to the noodle strings for 3 to 7 minutes.

6. The method of claim 1, wherein the steaming is performed by spraying water onto the noodle strings.

7. The method of claim 1, further comprising, after the steamed noodle strings are boiled, coating surfaces of the noodle strings with soybean polysaccharide and oil.

8. The method of claim 1, wherein the noodles are immediately cookable without an additional process of boiling the noodles.

9. The method of claim 1, wherein the noodles are udong noodles.

10. Instant food comprising:
the noodles according to claim 1; and
a cooking sauce.
